(19) United States
(12) Patent Application Publication
(10) Pub. No.: US 2022/0308742 A1
(43) Pub. Date: Sep. 29, 2022

(54) USER INTERFACE WITH METADATA CONTENT ELEMENTS FOR VIDEO NAVIGATION

(71) Applicant: Microsoft Technology Licensing, LLC, Redmond, WA (US)

(72) Inventors: Ori ZIV, Herzeliya (IL); Inbal SAGIV, Kfar-Saba (IL); Zvi FIGOV, Modiin (IL); Avi NEEMAN, Tel Aviv (IL); Nofar OREN EDAN, Tel Aviv (IL)

(21) Appl. No.: 17/238,942

(22) Filed: Apr. 23, 2021

Related U.S. Application Data
(60) Provisional application No. 63/165,493, filed on Mar. 24, 2021.

(51) Int. Cl. G06F 3/0484; G06F 16/71; G06F 16/74; G06F 16/78; G06F 3/0485; G06F 3/0488; G06F 16/783

(52) U.S. Cl. CPC G06F 3/04847; G06F 16/71; G06F 16/743; G06F 16/7867; G06F 3/04855; G06F 3/04886; G06F 16/784

(57) ABSTRACT

A video navigation and search tool includes a user interface that facilitates user interactions with indexed video content stored in a database. The user interface includes a library of thumbnail images that each individually depict a different subject associated in memory with a different detection identifier (ID). Each of the thumbnail images in the library is an image cropped from a single frame of a video file. Responsive to receiving a user selection of one of the thumbnail images associated with a first detection ID, the video navigation and search tool retrieves context metadata identifying frames in the video file indexed in the database in association with the first detection ID and presents video segment information on the user interface. The presented video segment information identifies one or more segments in the video file including the frames associated with the first detection ID.

### CROSS-REFERENCE TO RELATED APPLICATIONS

The present application claims priority to U.S. provisional patent application No. 63/165,493, entitled “User Interface with Metadata Content Elements for Video Navigation,” and filed on Mar. 24, 2021, which is hereby incorporated by reference for all that it discloses or teaches.

### BACKGROUND

The rise of cloud storage platforms has led to the development of massive cloud-based video databases from which users can playback content using different type of applications. The demand for video indexing and searching capability is higher than ever. For instance, in many cases—searching for particular portions and elements of a video may help to circumvent the need for a user to watch entire videos. However, existing video search tools and indexing systems are largely difficult to use and navigate without significant training or expertise. Video hosting services therefore continue to seek out interactive tools to help users navigate and interact with stored content.

### SUMMARY

According to one implementation, a video navigation and search tool includes a user interface that facilitates user interactions with indexed video content stored in a database. The user interface includes a library of thumbnail images cropped from frames of a video file that depict subjects associated in memory with different detection identifiers (IDs). Responsive to receiving a user selection of one of the thumbnail images associated with a first detection ID, the video navigation and search tool retrieves context metadata identifying frames in the video file indexed in the database in association with the first detection ID and presents video segment information on the user interface. The presented video segment information identifies one or more segments in the video file including the frames associated with the first detection ID.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example video management system (VMS) with a visualization layer that includes a graphical user interface linking user-selectable context metadata elements to media player controls to simplify video search and navigation and thereby help the user to quickly identify video segments of interest.

FIG. 2 illustrates aspects of an example thumbnail selector that may be included in a video management system and used to select thumbnails representative of video subjects.

FIG. 3 illustrates exemplary subject tracking features of a VMS system that rely on detection insights to track a subject throughout multiple frames of a video utilizing a video navigation and search tool.

FIG. 4 illustrates example operations for using a video index navigation tool to quickly identify and navigate to segments within a video that contain a subject of interest.

FIG. 5 illustrates an example schematic of a processing device suitable for implementing aspects of the disclosed technology.

### DETAILED DESCRIPTION

Video management systems may implement various types of image processing techniques to generate context metadata that may be used to index video content. As used herein, “context metadata” and “insights” are used interchangeably to refer to metadata that provides context about the content of a particular video, video frame, or sub-image extracted (cropped) from an individual frame. For example, a video management system may execute object and character recognition algorithms to generate data that is descriptive of the video content, such as keywords (descriptors) that are then stored in association with the video data and that may be used in a user-initiated query to retrieve videos and/or relevant parts of videos (clips, individual frames, etc.) from a database.

Although context metadata of different forms is widely generated and used to index data, there exist very few user-friendly tools for searching and reviewing content on the basis of such metadata. For example, some search engines provide search results that include filenames or timestamps, but no mechanism for quickly navigating through a video to identify portions relevant to a search query. Search results may, in some cases, include frame numbers and/or coordinates indicating a “bounding box” of interest. For example, the bounding box may indicate a subregion of a frame that is associated in memory with a particular character identifier or other keyword that may be used as a search term. However, even with a list of files, frame numbers, or pixel coordinates, identifying video segments of interest is still a cumbersome task since the user may then have to use a video viewing platform to review the video manually, self-navigate to frame numbers included in search results, etc.

A herein disclosed video management system (VMS) provides a graphical user interface (GUI) for searching, viewing, and interacting with video content that has been indexed in association with context metadata. The VMS includes a visualization layer that presents context metadata elements for a video as interactive GUI inputs that are selectable to invoke media presentation actions that illustrate, to the user, insights associating each context metadata element with associated segment(s) of the stored video data.

According to one implementation, the visualization layer logically integrates a video timeline with selectable context metadata elements such that selection of a given one of the context metadata elements causes the VMS to render, relative to the timeline, locations within the video corresponding to the selected metadata element. The video timeline may itself be an interactive GUI tool that interprets user selection of timeline location(s) as an instruction to initiate presentation of video content corresponding to those locations.

According to one further implementation, the selectable context metadata elements include a library of thumbnail images, where each of the thumbnail images represents an corresponding video subject (e.g., actor, character, object). The thumbnails are user-selectable GUI elements that are associated in memory with a collection of detections extracted from video frames (e.g., defined sub-frame areas) and context metadata that is specific to each of the detections. For example, each thumbnail may include an image representative of a subject that appears in a video. The thumbnail is associated, in memory, with frame number(s) in which the subject appears, bounding box coordinates indicating a sub-frame region including the subject within each of the associated frame numbers, and/or other context metadata specific to the subject or sub-frame region. When a user selects one of the thumbnail images from the GUI, the VSM renders, relative to the video timeline, video locations (e.g., frames or segments) that include the subject shown in the thumbnail image. Such locations are user-selectable to initiate rendering of portions of the video that include the subject and/or that are linked to context metadata stored in association with the thumbnail. The aforementioned logical and functional linkages between the interactive video timeline and the thumbnails in the thumbnail library provide the user with a way to effortlessly identify and review portions of a video that include a subject of interest.

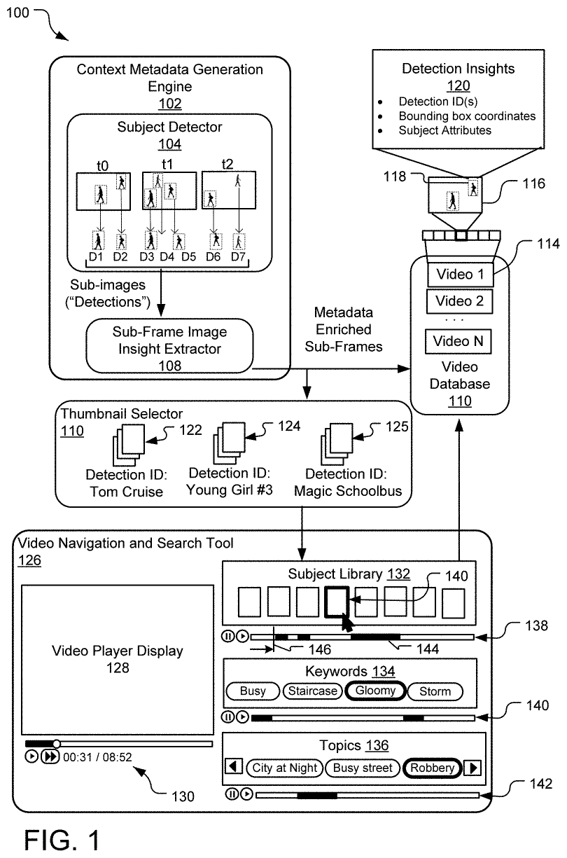

FIG. 1 illustrates an example video management system (VMS) 100 with a visualization layer that links user-selectable context metadata elements to media player controls to provide a user with a GUI (e.g., a video navigation and search tool) that facilitates quick identification and review of portions of a video indexed in association with context metadata of interest to the user. The VMS includes a context metadata generation engine 102 that generates context metadata in association with different granular aspects of the video such as in association with a particular scene of the video, frame of the video, or detection from within any individual frame of the video. In different implementations, context metadata generated by the context metadata generation engine 102 includes without limitation descriptors (e.g., keywords) for individual living or non-living subjects of the video (e.g., “person,” “crosswalk”, “bus,” “building”), labels descriptive of multiple elements of a frame or scene (e.g., “city at night,” “busy city sidewalk”), action identifiers (e.g., “sliding into home plate”), subject biometric data (e.g., subject height, eye or hair color, weight approximation), subject position data (e.g., tracking or bounding box coordinates), and more.

By example and without limitation, the context metadata generation engine 102 is shown including a subject detector 104 that analyzes individual frames of a video (e.g., frames corresponding to t0, t1, t2, etc.) to generate subject identifiers. The subject detector 106 detects subjects of a predefined type (e.g., people, animals, cars) in a given video in any suitable manner, such as by utilizing a trained image classifier to employ object recognition AI.

The subject detector 104 identifies, for each subject detected, a bounding box containing the subject, where the bounding box is defined by coordinates internal to a particular video frame. The imagery internal this bounding box is referred to herein as a “detection” (e.g., detections D1-D7 in FIG. 1). A subject that appears in a video may be associated with multiple detections extracted from the video where each detection corresponds to a different frame of the video in which the subject appears.

In one implementation, a sub-frame image insight extractor 108 receives the detections and associated information such as bounding box coordinates defining each detection, a frame number indicating the video frame including the detection, and/or various descriptors indicating characteristics of each detection. The sub-frame image extractor 108 performs further actions effective to generate context metadata (“insights”) associated with each of the detections. In one implementation, the sub-frame image extractor 108 includes a grouping engine (not shown) that groups together detections that corresponding to a same subject (e.g., creating one group associated with leading actor #1, another group associated with supporting actress #2, and so forth). The sub-frame image extractor 108 may also include a tracking engine (not shown) that generates tracking data based on each individual group—e.g., effectively allowing for a tracking of an individual subject across multiple frames of the video.

The sub-frame image insight extractor 108 may, in some implementations, also generate context metadata that identifies or characterizes physical attributes of subjects appearing within each of the detections (e.g., D1-D7). For example, the attribute “carrying briefcase” may be stored in association with detections of a subject in a first scene (e.g., where the subject is carrying a brief case) and the attribute “tuxedo” may be stored in association with detections of the same subject in a second scene (e.g., where the subject is wearing a tuxedo).

In one implementation, outputs of the sub-frame image insight extractor 108 include metadata-enriched detections (sub-frame images) that are stored in a video database 110 in association with the corresponding frame and video identifiers. For example, the video database 110 stores video files (e.g., video file 114) consisting of frames (e.g., a frame 116) and context metadata associated with each frame. This context metadata data for each frame may include detections for the frame (e.g., a detection 118), and each of the detections for an individual frame by be further associated with context metadata referred to herein as “detection insights 120.” For example, the detection insights 120 for the detection 118 may include a detection ID (e.g., a descriptive or non-descriptive identifier for a group of like-detections), bounding box coordinates indicating a location of each detection, and/or attributes describing visual characteristics of the subject included within the detection.

Although FIG. 1 and the following description focus primarily on the detection insights 120, the context metadata generation engine 102 may also generate insights that are specific to other granularities of a video file such as for a particular frame or scene. For example, the context metadata generation engine 102 may generate context metadata based on multiple subjects detected in a frame or visual attributes that pertain to a frame or scene as a whole rather than its individual subjects. This context metadata may be used in ways the same or similar to the detection insights 120, discussed below.

In FIG. 1, the VMS 100 includes a thumbnail selector 110 that selects a single thumbnail image to associate with each detection ID for a given video. As discussed above, the sub-frame image extractor 108 may group the sub-images into same-subject groups (e.g., groups 122, 124, 125) that each include sub-images associated with a same detection ID (e.g., detection IDs “Tom Cruise,” “Young Girl #3”). For each same-subject group of sub-images, the thumbnail selector 110 selects a single representative thumbnail image. This representative thumbnail image is added to a subject library 132 that is created for the associated video file. Each thumbnail image in the subject library 132 is associated in memory with a detection ID and therefore usable to identify all sub-images of the corresponding same-subject group created for that detection ID.

In FIG. 1, outputs of the thumbnail selector 110 and context metadata generation engine 102 are logically linked to interactive GUI elements of a video navigation and search tool 126, which is rendered by the VMS 100 to a user display. The video navigation and search tool 126 includes a video player display 128 and video control panel 130. A user may interact with the VMS 100 and/or the video navigation and search tool 126 to load a video from the video database 110 to the video player display 128. Using the video control panel 130, the user can navigate to various locations within the video and playback the video from those locations.

When a video is loaded to the video player display 128, the VMS 100 populates various user-selectable UI elements of the video navigation and search tool 126 with context metadata elements (e.g., thumbnail images in subject library 132, keywords 134, topics 136) that are stored in association with the video in the video database 110. These GUI elements function as interactive controls logically linked to a set of locations within the currently-loaded video. In the illustrated implementation, a user may select various context metadata elements in the video navigation and search tool 126 to cause the video navigation and search tool 126 to present video segment information illustrating locations or video segments within the currently-loaded video that are associated (e.g., in the video database 110) with the selected context metadata element. In FIG. 1, the video navigation and search tool 126 includes interactive video timelines 138, 140, and 142 corresponding to the video currently-loaded to the video player display 128 that are each usable to control a play pointer for video.

As discussed above, the subject library 132 includes thumbnail images (e.g., a thumbnail image 140) that are output by the thumbnail selector 110. Each thumbnail image in the subject library 132 is a detection extracted from one of the frames of the currently-loaded video file that is representative of a group of detections from the video that are stored in the video database 110 in association with a same detection ID. For example, the thumbnail image 140 may be a thumbnail image of actor Tom Cruise (associated with detection ID “Tom Cruise”) that is extracted from one of the frames of the currently-loaded video. Notably, the thumbnail image 140 is not necessarily extracted from a video frame that is concurrently displayed in the video player display 128.

When a particular thumbnail image is selected by a user, such as by mouse or touch input, the timeline 138 below the subject library is updated to indicate segments within the video file that include frames associated in the video database 110 with the detection ID of the selected thumbnail image. By example and without limitation, the timeline 138 includes shaded segments (e.g., a shaded segment 144) that each indicate a segment of the currently-loaded video that includes the subject associated with the detection ID for the user-selected thumbnail image (e.g., thumbnail image 140). A user may interact with GUI control elements of the timeline 138 (e.g., play, pause, dragging read pointer) to control a current position of a read pointer 146 for the currently loaded video. For example, the user can drag the read pointer 146 to the start of the shaded segment 144 to advance the read pointer of the currently-loaded video to this location and thereby view this portion of the video in the video player display 128. In doing so, the user is able to quickly view portions of the video that include the subject of interest identified by the detection ID associated with the selected thumbnail image 140.

Similar to the subject library 132, the video navigation and search tool 126 includes other interactive UI elements including a keyword box 134 and topics box 136 that present keywords and topics that are associated in the video database 110 with various frame(s) of the currently-loaded video. When a user provides input to a select one of the metadata content elements in the keyword box 134 or in the topics box 136, the video navigation and search tool 126 populates an associated video timeline (e.g., video timelines 140, 142) with graphics data indicating locations within the currently-loaded video that are associated in the video database with the selected context metadata element. For example, the gray areas on the video timeline 140 indicate segments of the currently-loaded video that have been indexed in the video database in associated with a user-selected keyword “Gloomy.”

The presentation of a video file alongside timeline data for the video file and selectable context metadata elements logically linked to locations within the video timeline provides the user with a seamless experience for locating video segments of interest without a high level of skill in software development, computing, or video data management in general. Other features of the video navigation and search tool 126 may similarly leverage timeline data for the video and/or otherwise facilitate search and exportation of video segments of interest, such as by providing fields that allow a user to search for keywords of interest, suggesting search keywords to a user based on other user inputs, and/or tools for cropping and exporting video segments that are of interest to a user.

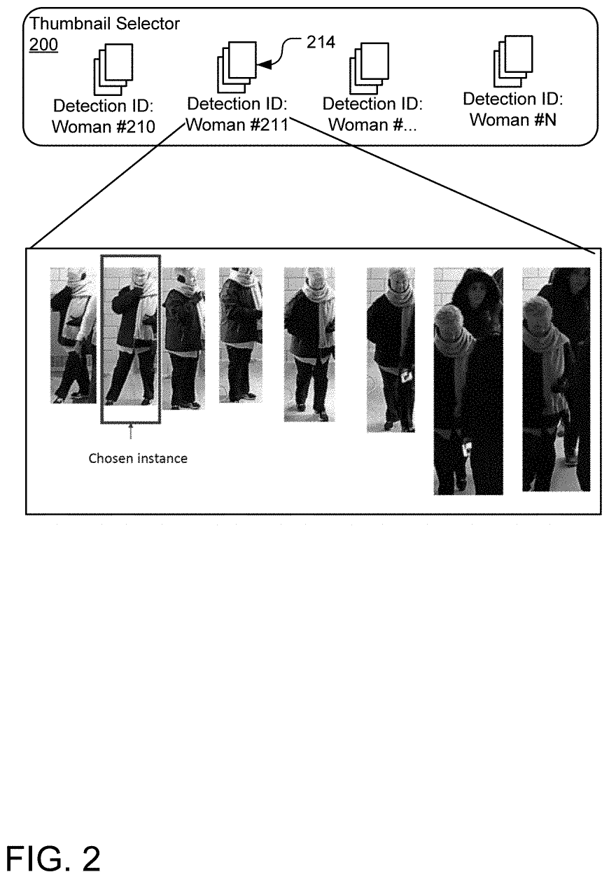

FIG. 2 illustrates aspects of an example thumbnail selector 200 that may be included in a video management system and used to select a thumbnail representative of each subject identified in association with a video. In one implementation, the thumbnail selector 200 is integrated into a system with components the same or similar as the video management system of FIG. 1. The thumbnail selector 200 may provide functionality the same or similar as the functionality discussed with respect to the thumbnail selector 110 of FIG. 1.

As input, the thumbnail selector 200 receives groups of detections (e.g., groups 202, 204, 206, and 208), where the detections of each group have been algorithmically associated with a same detection ID. Detection IDs may represent living or non-living video subjects that are recognized by image analysis and/or classification software, such as may be achieved using various AI models trained to recognize particular types of subjects (e.g., people), facial recognition models, or grouping/clustering algorithms. The detection ID for each group of detections may, in various implementations, be descriptive (e.g., character names, actor names, or subject type such as “woman”), purely numerical, and/or other form of identifier.

By example and without limitation, the thumbnail selector 200 is shown performing actions for selecting a thumbnail that is representative of a group 214 of detections from a single video, where all detections in the group have been previously associated in memory with a same detection ID “e.g., woman #211.”

In selecting a thumbnail image representative of each group of like-detections (e.g., the group 214), the thumbnail selector 200 employs logic to select a “best representative image.” In one implementation, the thumbnail image that is selected as the representative image for each of the groups of like-detections (e.g., the group 214) is added to a subject library for a given video, such as the subject library 132 shown and described with respect to FIG. 1. Since the representative images in the subject library 132 may visually help the user identify a video subject of interest and/or search for the subject within the video, it is beneficial for each of the chosen representative images in the subject library 132 to bear detail informing the user about the nature and/or characteristics of the subject of interest.

Selection of a best representative image from each of the groups 202, 204, 206, and 208 of detections may be achieved in a variety of ways. In one implementation, the thumbnail selector 200 computes a cost function for each image in a particular group and selects the image with an associated cost satisfying predefined criteria (e.g., the highest cost or lowest cost, depending on how the cost function is defined). The cost function depends on image characteristic(s) that may be selectively tailored to each use case.

One exemplary image characteristic that may be used as a basis for selecting a best representative image from each of the groups 202, 204, 206, and 208 of detections is subject height (e.g., in pixels). In one implementation, a larger height subject influences the cost function in a first direction such that the image is more likely to be selected as the representative thumbnail. Another exemplary image characteristic that may be used as a basis for selecting a best representative image from each group is “detection confidence,” which may be understood as a computed confidence in the likelihood that the image depicts the same subject as other images that have been associated with the same detection ID. A high detection confidence influences the cost function in the first direction such that the image is more likely to be selected as the representative thumbnail.

Yet another exemplary image characteristic that may be used as a basis for selecting a best representative image from each group is “degree of occlusion,” which may be understood as representing a degree to which the subject in the image is occluded by other subjects (e.g., people or objects). A lower degree of image occlusion influences the cost function in the first direction such that the image is more likely to be selected as the representative thumbnail. Yet another exemplary image characteristic that may be used as a basis for selecting a best representative image is the index of a given frame within a video file. If tracking software is used to track a subject throughout the video, such as using a bounding box of a given size, tracking errors may compound over time to gradually shift the center of the bounding box away from the center of the target subject. For this reason, detections cropped from frames with earlier indices may be more likely to be selected as representative thumbnails than detections cropped from frames with later indices in the video file.

By example and without limitation, one exemplary cost function utilized to select a representative thumbnail is given below with respect to Equation (1):

Cost=W1*NormalizedHeight+W2*DetectionConfidence*(1−NormalizedTime) (1)

where W1 and W2 are weights assigned to height and detection confidence, respectively; “normalizedheight” is the height of the subject divided by the frame height; “DetectionConfidence” is the computed confidence in the likelihood that the detection is correct (e.g., the likelihood that the detection depicts the same subject as other sub-images associated with the detection ID), and “NormalizedTime” is the index of the frame including the sub-image divided by the number of frames in the associated video file.

In one implementation employing the cost function of equation (1) above, the selected thumbnail image for a group of detections (e.g., the group 214) is the image that maximizes the computed cost. In various implementations, other image characteristics may be used in a cost function the same or similar to that above. For example, some implementations may consider subject pose, face size, facial expression, etc.

In some implementations, the detection ID assigned to each group of images (e.g., the group 214) is based on not only the subject within a frame but also based on one or more detected attributes of the subject. For example, a man that is carrying a bag in one video segment but not carrying the bag in another video segment may have first and second detection IDs reflecting the existence and non-existence of this attribute (e.g., “man+has bag” and “man−without bag”). In this case, a representative thumbnail image may be selected in association with each of the detection IDs and added to a thumbnail library used in a graphical user interface, such as the subject library 132 of FIG. 1. Using attributes in the creation of detection IDs may allow a user to conduct richer, more meaningful searches that are significantly accelerated by the herein disclosed GUI features that may, for example, allow a user to select a representative thumbnail image that bears not only a subject of interest but also one or more subject attributes of interest.

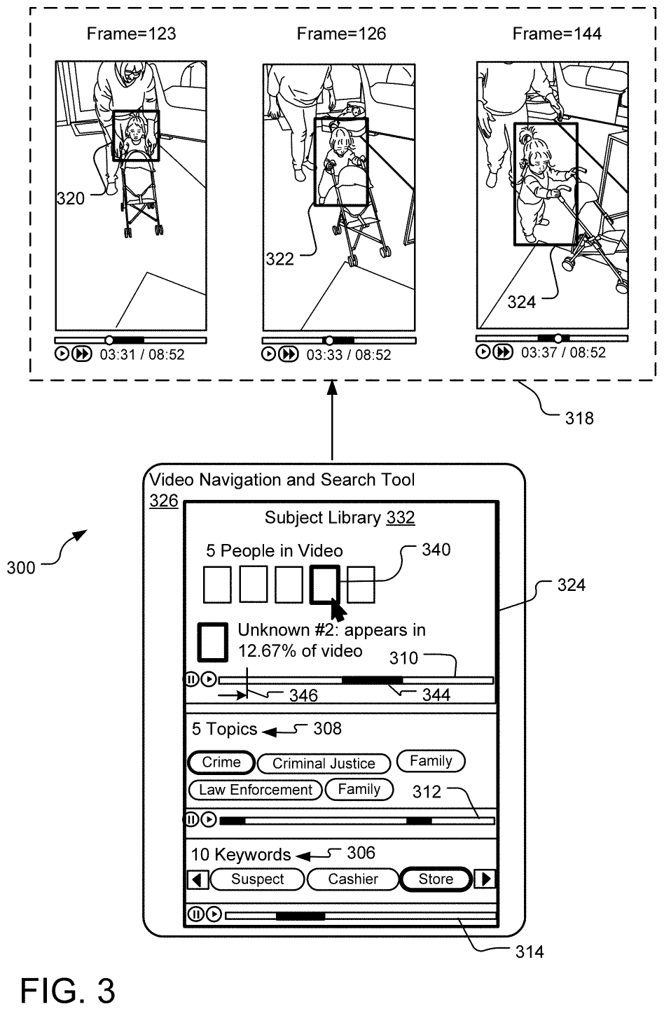

FIG. 3 illustrates exemplary subject tracking features of a VMS system 300 that rely on detection insights to track a subject throughout multiple frames of a video utilizing a video navigation and search tool 326. The video navigation and search tool 326 includes a GUI 304 that displays various context metadata for a loaded video file in the form of interactive UI elements that provide functionality the same or similar to UI elements discussed with respect to FIG. 1. In FIG. 3, the GUI 324 displays various keywords 306 and topics 308 as user selectable user-selectable elements that are logically linked to specifically locations (frames and multi-segments) within the video file. User selection of a displayed keyword or topic may, for example, cause the video navigation and search tool 326 to graphically alter an associated video timeline (e.g., interactive video timelines 312, 314) to indicate frames or video segments within a currently-loaded video that have been indexed in association with the selected keyword or topic.

In addition to displaying video keywords and topics as UI elements, the GUI 324 also displays a subject library 332 that includes a representative thumbnail image (e.g., a thumbnail image 340) for each of multiple different subjects that appear in the currently-loaded video. Each of the representative thumbnails in the subject library 332 is stored in association with detection insights for a group of like-detections. For example, the thumbnail image 340 is stored in association with a group of detections (images cropped from different frames of the video) that are assigned to a same detection ID as the thumbnail image, as well as bounding box coordinates and frame numbers associated with each detection.

When a user selects one of the thumbnail images from the subject library 332, such as the thumbnail image 310, the video navigation and search tool 326 modifies graphical information on an associated video timeline 310 to indicate one or more segments (e.g., a segment 344) within the video file that include detections assigned to a same detection ID as the selected thumbnail image. The user may then optionally provides a video navigation instruction, such as by clicking on the segment 314 or dragging a read pointer 346 to a start of the segment 344 along the interactive video timeline 310 to initiate a playback action. In response to receiving the video navigation instruction from the user at the interactive video timeline 310, the video navigation and search tool 326 initiates playback of the segment 344 from a video location (frame number) linked to the adjusted position of the read pointer 316.

While playing the segment 344 of the currently-loaded video in a media player display window (not shown), the video navigation and search tool 326 may overlay the selected segment with a bounding box or other graphical representation of coordinates stored in association with the detections having the same detection ID as the selected representative thumbnail image 310. For example, as shown in view 318, the video navigation and search tool 326 may display a bounding or tracking box over the detection in each frame corresponding to the selected representative thumbnail image 310. In effect, this bounding box “tracks” the subject of the representative thumbnail image 310 as that subjects moves throughout the scene in different frames of the selected segment 314 that all include detections associated with the same detection ID. By example and without limitation, view 318 three frames of a selected video segment (e.g., segment 344) that each include a detection (e.g., detections 320, 322, and 324) that is stored in association with a detection ID for a user-selected representative thumbnail image (e.g., thumbnail image 314). In all three of the illustrated exemplary frames, a bounding box (rectangle frame) is graphically overlaid with the frame to indicate an area of the frame that includes the subject shown in the selected representative thumbnail image 340.

This tracking feature enhances the functionality described above with respect to FIG. 1 by allowing a user to not only locate frame(s) containing a subject of interest, but to easily study the subject in those frames as the subject moves throughout the scene.

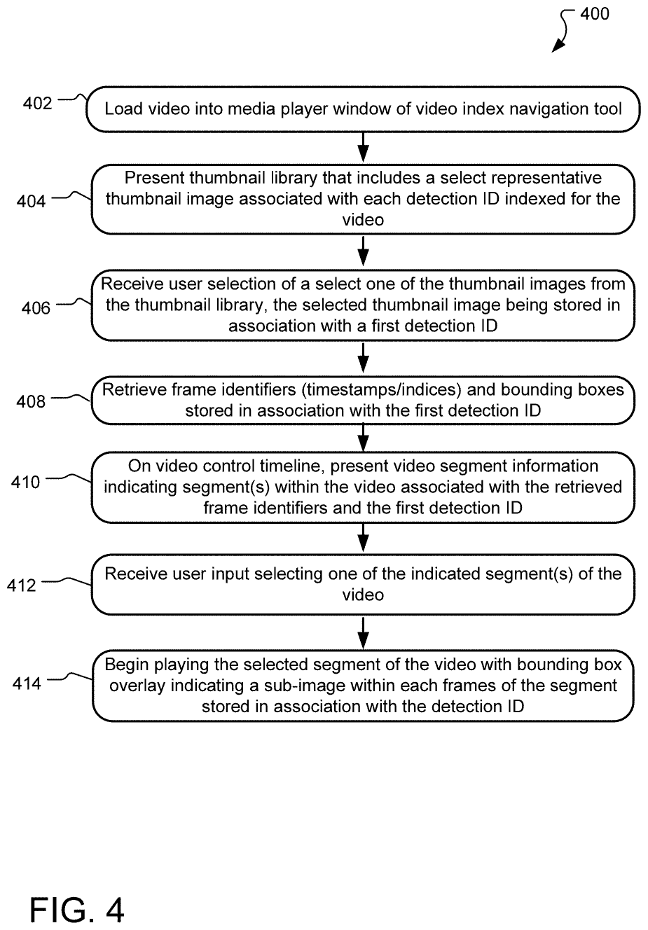

FIG. 4 illustrates example operations 400 for using a video index navigation tool that uses various types of context metadata as interactive UI elements linked to an interactive video timeline to allow a user to quickly identify and navigate to segments within a video that contain a subject (e.g., person) of interest. The video index navigation tool includes a GUI with a media player window, and a loading operation 402 loads a video into the media player window where it is presented alongside media player controls (e.g., a timeline, play/pause/stop buttons, etc.) that a user may interact with to navigate within and play portions of the loaded video.

A presentation operation 404 presents a thumbnail library in the GUI alongside the media player window. The thumbnail library includes a series of thumbnails, each of which is a sub-image area (detection) extracted from one of the frames of the loaded video; however, the thumbnail images shown in the thumbnail library are not necessarily extracted from the frame that is displayed in the media player window concurrent to the thumbnail library at a given point in time. Each one of the thumbnail images is stored in memory with a detection identifier (ID) that is associated with a group of sub-images extracted from different frames of the video. For example, during an initial video indexing process, the video is parsed to identify “detections” of a type of subject of interest (e.g., sub-images within each frame including people). Like-detections from different frames are grouped together, such as using a suitable clustering algorithm. Each group of like-detections is assigned a different detection ID. In some implementations, each detection ID is a non-descript identifier such as an index (e.g., unknown subject #301, 302, 303); in other implementations, each detection ID is descriptive of a particular subject shown in the sub-images of a given group (e.g., red-scarf woman, President Obama).

Thus, thumbnail library includes a single representative thumbnail that is associated with each different detection ID identified for the video. If, for example, a subject (e.g., red-scarf woman) appears in 14 frames of a video, a sub-image containing the subject is extracted from each of the 14 different frames and this group of 14 sub-images is the associated with a single detection ID represented by a single representative thumbnail image that is included in the thumbnail library.

A user input receipt operation 406 receives a user selection of a select one of the thumbnail images from the thumbnail library. The selected thumbnail image is associated in memory with a first detection ID. A retrieving operation 408 retrieves detection insights, such as frame identifiers (indices), and bounding box information (coordinates) associated with the first detection ID for different frame numbers. If included, the bounding box information may define a sub-image within a given frame that includes the subject that is associated with the detection ID.

Another presentation operation 410 presents, on an interactive video timeline, video segment information indicating segment(s) within the loaded video that are associated in memory with the retrieved frame identifiers and the first detection ID. For example, an interactive video timeline may have a beginning and end that correspond to the first and last frames of the currently loaded video. Graphical information or UI elements is presented along this timeline (e.g., shaded boxes, start/stop pointers) to indicate one or more segments within the video that include frame(s) including sub-images indexed in association with the first detection ID. From this visual video segment information, a user can easily identify which segments in a video include subject of interest and also navigate to such segments by interacting with UI elements on the video control timeline.

Another input receipt operation 412 receives user input selecting one of the indicated segment(s) on the video control timeline that includes image content indexed in association with the first detection ID. For example, the user may drag a play pointer to, click on, or otherwise select one of the video segments rendered by the presenting operation 410. Responsive to receipt of such input, a media playback operation 414 begins playing the selected segment of the video. For example, the media playback operation 414 advances a current position of a video read pointer to a start of the user-selected segment. In one implementation, the media playback operation 414 also presents a subject tracking box, such as a rectangle drawn to indicate bounding box coordinates around the subject of interest (e.g., the subject associated with the first detection ID) in each frame of the selected segment that includes the subject of interest. As the segment is played, the subject tracking box dynamically changes position to match corresponding positional changes of the subject of interest, thereby visually “tracking” the subject of interest as it moves throughout the multiple frames of the selected segment.

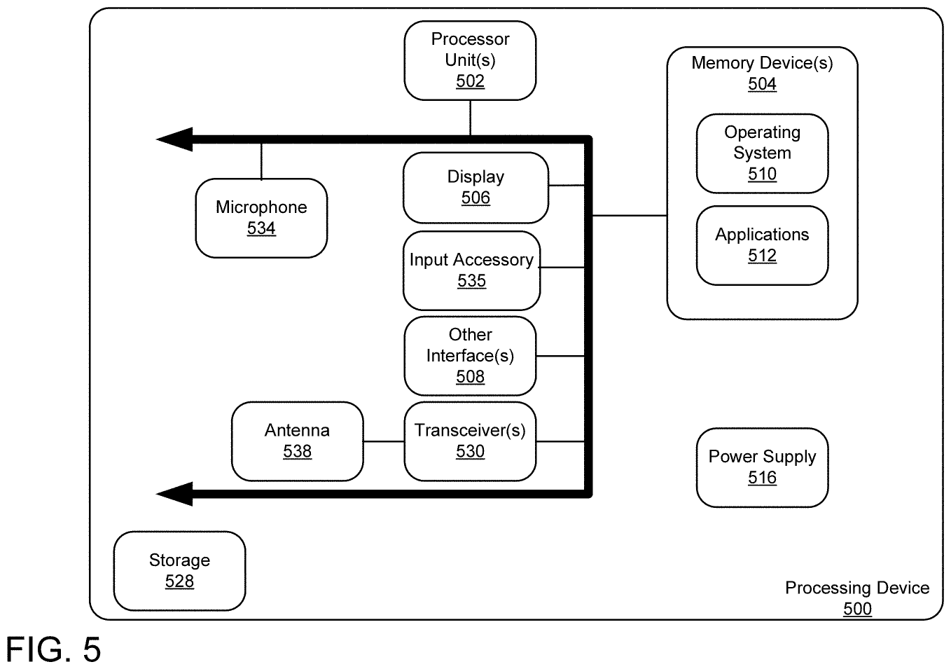

FIG. 5 illustrates an example schematic of a processing device 500 suitable for implementing aspects of the disclosed technology. The processing device 500 includes one or more processor unit(s) 502, memory device(s) 504, a display 506, and other interfaces 508 (e.g., buttons). The processor unit(s) 502 may each include one or more CPUs, GPUs, etc.

The memory 504 generally includes both volatile memory (e.g., RAM) and non-volatile memory (e.g., flash memory). An operating system 510, such as the Microsoft Windows® operating system, the Microsoft Windows® Phone operating system or a specific operating system designed for a gaming device, may resides in the memory 504 and be executed by the processor unit(s) 502, although it should be understood that other operating systems may be employed.

One or more applications 512 (e.g., the context metadata generation engine 104 of FIG. 1, the thumbnail selector 110 of FIG. 1, or the video navigation and search tool of FIG. 1) are loaded in the memory 504 and executed on the operating system 510 by the processor unit(s) 502. The applications 512 may receive inputs from one another as well as from various input local devices such as a microphone 534, input accessory 535 (e.g., keypad, mouse, stylus, touchpad, gamepad, racing wheel, joystick), and a camera 532. Additionally, the applications 512 may receive input from one or more remote devices, such as remotely-located smart devices, by communicating with such devices over a wired or wireless network using more communication transceivers 530 and an antenna 538 to provide network connectivity (e.g., a mobile phone network, Wi-Fi®, Bluetooth®). The processing device 500 may also include one or more storage devices 528 (e.g., non-volatile storage). Other configurations may also be employed.

The processing device 500 further includes a power supply 516, which is powered by one or more batteries or other power sources and which provides power to other components of the processing device 500. The power supply 516 may also be connected to an external power source (not shown) that overrides or recharges the built-in batteries or other power sources.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

An example video management system disclosed herein includes memory and a video navigation and search tool stored in the memory. The video navigation and search tool is executable to generate a user interface that facilitates user interactions with indexed video content stored in a database. In one implementation, the user interface includes a library of thumbnail images that are each cropped from an associated frame of a video file and that each individually depict a different subject associated in the memory with a different detection identifier (ID). The video navigation and search tool is further executable to receive, at the user interface, a user selection of one of the thumbnail images associated with a first detection ID, retrieve context metadata identifying frames in the video file indexed in the database in association with the first detection ID responsive to receipt of the user selection, and present video segment information on the user interface. The video segment information identifies one or more segments in the video file including the frames associated with the first detection ID.

In an example video management system of any preceding system, the video segment information includes graphical information that is presented relative to an interactive video timeline for the video file and the user interface is further configured to initiate playback of a selected segment of the one or more identified segments responsive to receipt of user input at the interactive video timeline.

In still another example video management system of any preceding system, each of the thumbnail images in the library depicts a different subject that appears in one or more frames of the video file.

In yet another example video management system of any preceding system, each of the thumbnail images in the library is stored in association with a collection of sub-images cropped from different frames of the video file. The sub-images within the collection are associated with a same detection ID.

In another example video management system of any preceding system, each of the thumbnail images in the library is further stored in association with bounding box coordinates and a frame index for each of the sub-images in the associated collection. The user interface is further configured to use the bounding box coordinates and frame index for the collection of images associated with the selected thumbnail image to present a bounding box that tracks the subject while playing back multiple frames of the video file.

In still yet another example video management system of any preceding system, each of the thumbnail images is selected for inclusion in the library from a collection of sub-images associated with the same detection ID based on a cost function computed for each of the sub-images. The cost function depends upon at least one image characteristic selected from the group consisting of a computed confidence in an association between a subject included in the sub-image and the at least one detection identifier, a size of the subject included in the sub-image, and a degree to which the subject included in the sub-image is occluded by other objects in the sub-image. The cost function is influenced in a first direction more when: (1) the computed confidence is higher than when the computed confidence is lower; (2) when the size is larger than when the size is smaller; and (3) when the subject is occluded less than when the subject is occluded more. The method further provides for selecting one of the thumbnail images for inclusion in the library from the collection of sub-images associated with the same detection ID, where the selection is based on the cost function computed for each of the sub-images.

In still another example video management system of any preceding system, the user interface is further configured to receive input from the user selecting a frame within the video file associated with the at least one detection ID. In response to the receipt of the user input, the user interface is configured to reposition a read pointer of a video file at the selected frame and initiate playback of the video file from the repositioned read pointer position.

An example method disclosed herein provides for presenting, via a graphical user interface, a library of thumbnail images that each individually depict a different subject associated in memory with a different detection identifier (ID). Each of the thumbnail images is cropped from an associated frame of a video file. The method further provides for receiving, at the graphical user interface, a user selection of one of the thumbnail images associated with a first detection ID and for retrieving context metadata identifying frames in the video file indexed in the database in association with the first detection ID responsive to receipt of the user selection. The method further provides for presenting video segment information on the user interface that identifies one or more segments in the video file including the frames associated with the first detection ID.

In yet another example method of any preceding method, the video segment information includes graphical information that is presented relative to an interactive video timeline for the video file, and the user interface is further configured to initiate playback of a selected segment of the one or more identified segments responsive to receipt of user input at the interactive video timeline.

In still yet another example method of any preceding method, each of the thumbnail images in the library depicts a different subject that appears in one or more frames of the video file.

In still yet another example method of any preceding method, each of the thumbnail images in the library is stored in association with a collection of sub-images cropped from different frames of the video file. The sub-images within the collection are associated with a same detection ID.

In yet another example method of any preceding method, each of the thumbnail images in the library is further stored in association with bounding box coordinates and a frame index for each of the sub-images in the associated collection, and the user interface is further configured to use the bounding box coordinates and frame index for the collection of images associated with the selected thumbnail image to present a bounding box that tracks a subject while playing back multiple frames of the video file.

In another example method of any preceding method, the method further comprises computing a cost function for each image in a collection of sub-images associated with a same detection ID. The cost function depends upon at least one image characteristic selected from the group consisting of a computed confidence in an association between a subject included in the sub-image and the at least one detection identifier, a size of the subject included in the sub-image, and a degree to which the subject included in the sub-image is occluded by other objects in the sub-image. The cost function is influenced in a first direction more when: (1) the computed confidence is higher than when the computed confidence is lower; (2) when the size is larger than when the size is smaller; and (3) when the subject is occluded less than when the subject is occluded more. The method further provides for selecting one of the thumbnail images for inclusion in the library from the collection of sub-images associated with the same detection ID, where the selection is based on the cost function computed for each of the sub-images.

In still another example method of any preceding method, the method includes receiving input from the user selecting a frame within the video file associated with the at least one detection ID; repositioning a read pointer of a video file at the selected frame responsive to receipt of the input selecting the frame; and initiating playback of the video file from the repositioned read pointer position.

An example computer-readable storage media storage media disclosed herein encodes computer-executable instructions for executing a computer process. The computer process comprises presenting, via a graphical user interface, a library of thumbnail images that each individually depict a different subject associated in memory with a different detection identifier (ID) and that are each cropped from an associated frame of a video file; receiving, at the graphical user interface, a user selection of one of the thumbnail images associated with a first detection ID; retrieving context metadata identifying frames in the video file indexed in the database in association with the first detection ID responsive to receipt of the user selection; and presenting video segment information on the user interface, the video segment information identifying one or more segments in the video file including the frames associated with the first detection ID.

In an example computer process of any preceding computer process, the video segment information includes graphical information that is presented relative to an interactive video timeline for the video file and the user interface is further configured to initiate playback of a selected segment of the one or more identified segments responsive to receipt of user input at the interactive video timeline.

In still yet another example computer process of any preceding computer process, each of the thumbnail images in the library depicts a different subject that appears in one or more frames of the video file.

In another example computer process of any preceding computer process, each of the thumbnail images in the library is stored in association with a collection of sub-images cropped from different frames of the video file, the sub-images within the collection being associated with a same detection ID.

In still another example computer process of any preceding computer process, each of the thumbnail images in the library is further stored in association with bounding box coordinates and a frame index for each of the sub-images in the associated collection. The interface is further configured to use the bounding box coordinates and frame index for the collection of images associated with the selected thumbnail image to present a bounding box that tracks a subject while playing back multiple frames of the video file.

In yet another example computer process of any preceding computer process, the computer process further comprises computing a cost function for each image of a collection of sub-images associated with a same detection ID. The cost function depends upon at least one image characteristic selected from the group consisting of a computed confidence in an association between a subject included in the sub-image and the at least one detection identifier, a size of the subject included in the sub-image, and a degree to which the subject included in the sub-image is occluded by other objects in the sub-image. The cost function is influenced in a first direction more when: (1) the computed confidence is higher than when the computed confidence is lower; (2) when the size is larger than when the size is smaller; and (3) when the subject is occluded less than when the subject is occluded more. The method further provides for selecting one of the thumbnail images for inclusion in the library from the collection of sub-images associated with the same detection ID, where the selection is based on the cost function computed for each of the sub-images.

An example system disclosed herein includes a means for presenting, via a graphical user interface, a library of thumbnail images that each individually depict a different subject associated in memory with a different detection identifier (ID) and that are each cropped from an associated frame of a video file. The system further includes a means for receiving, at the graphical user interface, a user selection of one of the thumbnail images associated with a first detection ID, and a means for retrieving context metadata identifying frames in the video file indexed in the database in association with the first detection ID responsive to receipt of the user selection. The system further includes a means for presenting video segment information on the user interface, the video segment information identifying one or more segments in the video file including the frames associated with the first detection ID.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A video management system comprising:
memory;
a video navigation and search tool stored in the memory and executable to:
generate a user interface that facilitates user interactions with indexed video content stored in a database, the user interface including a library of thumbnail images that are each cropped from an associated frame of a video file and that each individually depict a different subject associated in the memory with a different detection identifier (ID),
receive, at the user interface, a user selection of one of the thumbnail images associated with a first detection ID;
responsive to receipt of the user selection, retrieve context metadata identifying frames in the video file indexed in the database in association with the first detection ID; and
present video segment information on the user interface, the video segment information identifying one or more segments in the video file including the frames associated with the first detection ID.

2. The system of claim 1, wherein the video segment information includes graphical information that is presented relative to an interactive video timeline for the video file and the user interface is further configured to initiate playback of a selected segment of the one or more identified segments responsive to receipt of user input at the interactive video timeline.

3. The system of claim 1, wherein each of the thumbnail images in the library depicts a different subject that appears in one or more frames of the video file.

4. The system of claim 1, wherein each of the thumbnail images in the library is stored in association with a collection of sub-images cropped from different frames of the video file, the sub-images within the collection being associated with a same detection ID.

5. The system of claim 4, wherein each of the thumbnail images in the library is further stored in association with bounding box coordinates and a frame index for each of the sub-images in the associated collection, wherein the user interface is further configured to use the bounding box coordinates and frame index for the collection of images associated with the selected thumbnail image to present a bounding box that tracks the subject while playing back multiple frames of the video file.

6. The system of claim 1, wherein each of the thumbnail images is selected for inclusion in the library from a collection of sub-images associated with the same detection ID based on a cost function computed for each of the sub-images, the cost function depending upon at least one image characteristic selected from the group consisting of:
a computed confidence in an association between a subject included in the sub-image and the at least one detection identifier, wherein the cost function is influenced in a first direction more when the computed confidence is higher than when then computed confidence is lower;
a size of the subject included in the sub-image, wherein the cost function is influenced more in the first direction when the size is larger than when the size is smaller; and
a degree to which the subject included in the sub-image is occluded by other objects in the sub-image, wherein the cost function is influenced more in the first direction when the subject is occluded less than when the subject is occluded more.

7. The system of claim 1, wherein the user interface is further configured to receive input from the user selecting a frame within the video file associated with the at least one detection ID and, in response to the receipt of the user input, configured to:
reposition a read pointer of a video file at the selected frame; and
initiate playback of the video file from the repositioned read pointer position.

8. A method comprising:
presenting, via a graphical user interface, a library of thumbnail images that each individually depict a different subject associated in memory with a different detection identifier (ID), each of the thumbnail images being cropped from an associated frame of a video file;
receiving, at the graphical user interface, a user selection of one of the thumbnail images associated with a first detection ID;
responsive to receipt of the user selection, retrieving context metadata identifying frames in the video file indexed in the database in association with the first detection ID; and
present video segment information on the user interface, the video segment information identifying one or more segments in the video file including the frames associated with the first detection ID.

9. The method of claim 8, wherein the video segment information includes graphical information that is presented relative to an interactive video timeline for the video file and the user interface is further configured to initiate playback of a selected segment of the one or more identified segments responsive to receipt of user input at the interactive video timeline.

10. The method of claim 8, wherein each of the thumbnail images in the library depicts a different subject that appears in one or more frames of the video file.

11. The method of claim 8, wherein each of the thumbnail images in the library is stored in association with a collection of sub-images cropped from different frames of the video file, the sub-images within the collection being associated with a same detection ID.

12. The method of claim 11, wherein each of the thumbnail images in the library is further stored in association with bounding box coordinates and a frame index for each of the sub-images in the associated collection, wherein the user interface is further configured to use the bounding box coordinates and frame index for the collection of images associated with the selected thumbnail image to present a bounding box that tracks a subject while playing back multiple frames of the video file.

13. The method of claim 11, further comprising:
computing a cost function for each image of a collection of sub-images associated with a same detection ID, the cost function depending upon at least one image characteristic selected from the group consisting of:
a computed confidence in an association between a subject included in the sub-image and the at least one detection identifier, wherein the cost function is influenced in a first direction more when the computed confidence is higher than when then computed confidence is lower;
a size of the subject included in the sub-image, wherein the cost function is influenced more in the first direction when the size is larger than when the size is smaller;
a degree to which the subject included in the sub-image is occluded by other objects in the sub-image, wherein the cost function is influenced more in the first direction when the subject is occluded less than when the subject is occluded more; and
selecting one of the thumbnail images for inclusion in the library from the collection of sub-images associated with the same detection ID, the selection being based on the cost function computed for each of the sub-images.

14. The method of claim 8, further comprising:
receiving input from the user selecting a frame within the video file associated with the at least one detection ID;
responsive to receipt of the input selecting the frame, repositioning a read pointer of a video file at the selected frame; and
initiating playback of the video file from the repositioned read pointer position.

15. One or more computer-readable storage media encoding computer-executable instructions for executing a computer process, the computer process comprising:
presenting, via a graphical user interface, a library of thumbnail images that each individually depict a different subject associated in memory with a different detection identifier (ID), each of the thumbnail images being cropped from an associated frame of a video file;
receiving, at the graphical user interface, a user selection of one of the thumbnail images associated with a first detection ID;
responsive to receipt of the user selection, retrieving context metadata identifying frames in the video file indexed in the database in association with the first detection ID; and
presenting video segment information on the user interface, the video segment information identifying one or more segments in the video file including the frames associated with the first detection ID.

16. The one or more computer-readable storage media of claim 15, wherein the video segment information includes graphical information that is presented relative to an interactive video timeline for the video file and the user interface is further configured to initiate playback of a selected segment of the one or more identified segments responsive to receipt of user input at the interactive video timeline.

17. The one or more computer-readable storage media of claim 15, wherein each of the thumbnail images in the library depicts a different subject that appears in one or more frames of the video file.

18. The one or more computer-readable storage media of claim 15, wherein each of the thumbnail images in the library is stored in association with a collection of sub-images cropped from different frames of the video file, the sub-images within the collection being associated with a same detection ID.

19. The one or more computer-readable storage media of claim 15, wherein each of the thumbnail images in the library is further stored in association with bounding box coordinates and a frame index for each of the sub-images in the associated collection, wherein the user interface is further configured to use the bounding box coordinates and frame index for the collection of images associated with the selected thumbnail image to present a bounding box that tracks a subject while playing back multiple frames of the video file.

20. The one or more computer-readable storage media of claim 15, wherein the computer process further comprises:
computing a cost function for each image of a collection of sub-images associated with a same detection ID, the cost function depending upon at least one image characteristic selected from the group consisting of:
a computed confidence in an association between the subject included in the sub-image and the at least one detection identifier, wherein the cost function is influenced in a first direction more when the computed confidence is higher than when then computed confidence is lower;
a size of the subject included in the sub-image, wherein the cost function is influenced more in the first direction when the size is larger than when the size is smaller; and
a degree to which the subject included in the sub-image is occluded by other objects in the sub-image, wherein the cost function is influenced more in the first direction when the subject is occluded less than when the subject is occluded more; and
selecting one of the thumbnail images for inclusion in the library from the collection of sub-images associated with the same detection ID, the selection being based on the cost function computed for each of the sub-images.
